(19) United States
(12) Patent Application Publication
(10) Pub. No.: US 2012/0153838 A1
(43) Pub. Date: Jun. 21, 2012

(54) COGNITIVE IDENTIFIER ASSIGNMENT FOR LIGHT SOURCE CONTROL

(75) Inventors: Tim Corneel Wilhelmus Schenk, Eindhoven (NL); Johan Cornelis Talstra, Eindhoven (NL); Hendricus Theodorus Gerardus Maria Penning De Vries, Mierlo (NL); Lorenzo Feri, Eindhoven (NL)

(73) Assignee: KONINKLIJKE PHILIPS ELECTRONICS N.V., EINDHOVEN (NL)

(21) Appl. No.: 13/392,533

(22) PCT Filed: Aug. 25, 2010
(86) PCT No.: PCT/IB2010/053819

§ 371 Date: Feb. 27, 2012

(30) Foreign Application Priority Data
Aug. 27, 2009 (EP) 09168837.4

(51) Int. Cl. H05B 37/02

(52) U.S. Cl. 315/151

(57) ABSTRACT

Coded light has been proposed to enable advanced control of light sources and transmit information using light sources. Methods, devices and systems configured to operate a coded lighting control system, which is robust to interference from other sources of light are proposed. The method is based on sensing the light by a remote control device, and based on the sensing result adapting the identifiers used by the different light sources. By assigning a code identifier to the light source based on light received by the light receiver the code identifiers may be selected such that the influence of light interfering with the light source identifiers may be mitigated.

### FIELD OF THE INVENTION

The present invention relates to operating a lighting control system. Particularly it relates to methods and devices for operating a lighting control system comprising a plurality of light sources each of which is enabled to emit coded light.

### BACKGROUND OF THE INVENTION

The use of visible light (VL) and infra-red (IR) communications for the selection and advanced control of light sources has previously been proposed, and will be referred to as coded light (CL). For the transmission of CL, mostly, light emitting diodes (LEDs) are considered, which allow for a reasonable high modulation bandwidth. This in turn may result in a fast response of the control system. The feasibility to embed identifiers in the light of other light source types (incandescent, halogen, fluorescent and high-intensity discharge (HID) lamps) has also been shown.

These light source identifiers, or codes, allow for applications such as commissioning, light source selection and interactive scene setting. These applications have use in, for example, homes, offices, shops and hospitals. The light source identifiers enable a simple and intuitive control operation of a light system, which otherwise might be very complex.

Since there is no regulation of the visible light (VL) frequency band, methods and devices for operating coded lighting systems are in general sensitive to certain interfering light sources. For IR there is a narrow band which is kept relatively “clean” from interference, e.g. as mainly used for audio and video remote controls. This band, however, is not wide enough to accommodate enough light sources for the considered systems. Also, these IR-based remote control devices could create interference for the envisioned coded lighting systems. Hence, also for the IR frequency bands there is potential interference from other sources of light. It is noted, furthermore, that the sources of interference can be very location and time dependent.

### SUMMARY OF THE INVENTION

It is an object of the present invention to overcome this problem, and to provide a method and system concept which mitigates the dependency of the selection performance on local and current light interference. Generally, the above objectives are achieved by a remote controller according to the attached independent claim.

According to a first aspect, the above objects are achieved by a remote controller for assigning a code identifier to a light source in a coded lighting system, comprising: a light receiver; a processing unit arranged to assign a code identifier to the light source based on light received by the light receiver, the code identifier identifying a code to be used by the light source to emit coded light and being distinguishable in presence of the light; and a transmitter arranged to transmit the code identifier to the light source.

This provides a remote controller which takes the received light into account when assigning identifiers. By assigning a code identifier to the light source based on light received by the light receiver the code identifiers may be selected such that the influence of light interfering with the light source identifiers may be mitigated. Thereby an improved assignment of code identifiers for the coded light may be achieved. The assignment may for example result in identifiers that are more robust to the received light (incl. interference).

The applied technique only needs to be implemented in the remote controller. In other words, by using the claimed remote controller the remaining components of the lighting control system may remain unaltered. This provides a simple implementation.

The proposed remote controller can be used in different environments, where different light interference might occur. Particularly, it can be applied in different environment such as schools, theaters, offices, homes, outdoor and hotels, where typically different types of light interference might be present. Advantageously, also the light sources and remote controllers can be moved from one environment to another environment and still function correctly.

The remote controller and related light sources can handle yet unknown other light sources creating light interference for the coded lighting system. When such light sources are present the system can be adjusted by assigning the code identifiers based on the sensed light.

The remote controller automatically selects and assigns the code identifier, without intervention of the end user. This reduces the possibility of errors and provides a simple solution for the user of the system.

The processing unit may be arranged to assign the code identifier based on a correlation between the received light and a plurality of (predefined) light source identifiers. This provides a simple implementation of the assignment procedure.

Out of the plurality of light source identifiers the code identifier may correspond to a light source identifier having a minimum correlation with the received light.

This provides that the light source identifier being “most orthogonal” to the received light may be selected.

The processing unit may be arranged to determine the correlation for a subset of the plurality of light source identifiers. Thus by using only a subset of the plurality of light source identifiers the computational complexity may be reduced. Also, the code identifiers selection may be achieved in a shorter time.

A filter bank may be utilized to determine the correlation. The use of a filter bank may further simplify the implementation of the correlation. For example, the filter bank may be implemented using a Fourier transform, using processing in the frequency domain.

The receiver may be arranged to receive coded light from the light source, and the assigning may be based on the received coded light. This provides that the remote controller may be able to assign an identifier to a light source emitting both coded and un-coded light such that the un-coded light does not interfere with the coded light.

The received light may comprise light at least partly originating from at least one further light source. The at least one further light source may be excluded from the coded lighting system. Such a further light source may be any other natural or artificial light source. This provides that the remote controller may be able to, during the assigning, take into consideration light originating from unknown light sources not being part of the lighting control system.

The lighting system may comprise a plurality of light sources, and the processing unit may be arranged to assign a plurality of code identifiers to the plurality of light sources based on the received light, and the transmitter may be arranged to transmit the plurality of code identifiers to the plurality of light sources. This provides that the remote controller may be arranged to simultaneously assign a plurality of code identifiers based on a single received measurement of light. Thereby a fast assignment procedure may be achieved.

The processing unit may be arranged to estimate a power level of the received light, and the power level may be utilized to set a detection threshold in the processing unit. The processing unit may be arranged to estimate a profile from a group consisting of a temporal profile and a spectral profile of the received light. The profile may be utilized to set a filter response in the processing unit. At least one setting of the receiver may be based on the code identifier. The setting of a detection threshold, filter response, and/or setting of the receiver may improve the result produced by the processing unit since the processing unit may perform more accurate calculations. This provides that the remote controller may adapt its settings based on the received light, thereby facilitating improved assignment of identifiers. Additionally, this will yield an improved performance in the actual controlling of the light sources, since a more reliable identification of the light sources will be achieved.

The remote controller may further comprise a memory for storing data pertaining to a previously performed assignment of code identifier(s), and the code identifier(s) may be assigned based on the data. Thus by taking into account previous assignments and the results thereof the remote controller may be arranged to iteratively apply the assigning process, thereby achieving improved identifiers.

According to a second aspect, the above objects are achieved by a method for assigning a code identifier to a light source in a coded lighting system, comprising the steps of: receiving light; assigning a code identifier to the light source based on the received light, the code identifier identifying a code to be used by the light source to emit coded light and being distinguishable in presence of the light; and transmitting the code identifier to the light source.

According to a third aspect, the above objects are achieved by method of operating a coded lighting system comprising a remote controller and a light source enabled to emit coded light, the method comprising the steps of: assigning a code identifier to the light source according to a method as disclosed above; and emitting, from the light source, coded light based on the code.

A method to improve the reliability and interference robustness of coded light (VL and IR) based light control systems, may thus be summarized as comprising the following steps: sensing the light to characterize the light interference, selecting a (set of) light identifier(s) least sensitive to the locally experienced interference, and communicating this/these identifier(s) to the light source(s), where after the light source(s) applies/apply this/these identifier(s) in the next coded light transmission. It is noted that the invention relates to all possible combinations of features recited in the claims.

### BRIEF DESCRIPTION OF THE DRAWINGS

These and other aspects of the present invention will now be described in more detail, with reference to the appended drawings showing embodiment(s) of the invention.

FIG. 1 is a lighting system according to an embodiment;

FIG. 2 is a light source according to an embodiment;

FIG. 3 is a remote controller according to prior art;

FIG. 4 is a remote controller according to an embodiment; and

FIGS. 5-6 are flowcharts according to embodiments.

### DETAILED DESCRIPTION

The below embodiments are provided by way of example so that this disclosure will be thorough and complete, and will fully convey the scope of the invention to those skilled in the art. Like numbers refer to like elements throughout.

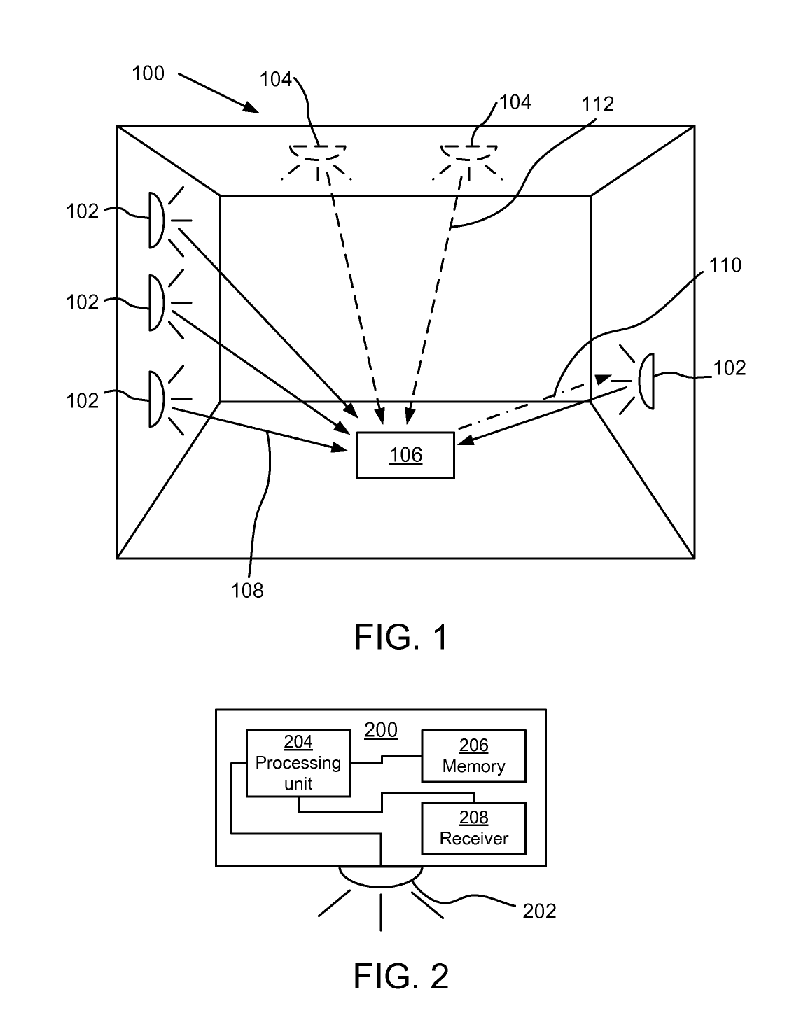

FIG. 1 illustrates a lighting system 100 comprises at least one light source, schematically denoted by the reference numeral 102. The light source 102 may be part of a lighting control system. It should be noted that the term “light source” means a device that is used for providing light in a room, for purpose of illuminating objects in the room. Examples of such light providing devices include lighting devices and luminaires. A room is in this context typically an apartment room or an office room, a gym hall, a room in a public place or a part of an outdoor environment, such as a part of a street. Each light source 102 is capable of emitting light, as schematically illustrated by the arrow 108. The emitted light comprises a modulated part associated with coded light comprising a light source identifier. The light source identifier is selected by using a code identifier. The emitted light may also comprise an un-modulated part associated with an illumination contribution. Each light source 102 may be associated with a number of lighting settings, inter alia pertaining to the illumination contribution of the light source, such as color, color temperature and intensity of the emitted light. In general terms the illumination contribution of the light source may be defined as a time-averaged output of the light emitted by the light source 102.

The system 100 may further comprise one or more additional light sources 104 which are not part of the lighting control system. In other words, the light sources 104 may be said to be excluded from the lighting control system. The one or more additional light sources 104 may be of natural origin, such as the sun. Alternatively, they may have the same properties as the light source 102 of the lighting control system, but are in this respect regarded as external, or interfering light sources. That is, the light emitted from the light source 104 may comprise a modulated part as well as an un-modulated part. As an example, the light sources 102 of the lighting control system may use light source identifiers based on pulse width modulation, whereas the light sources 104 excluded from the lighting control system may use light source identifiers based on frequency division modulation. Since the light source identifiers are based on different modulation techniques the light source identifiers of the light sources 104 excluded from the lighting control system may in such a case not be detectable by devices in the lighting control system. Thus, from the perspective of the lighting control system light emitted by the one or more additional light sources 104 is considered to comprise an illumination contribution only.

The system 100 further comprises an apparatus 106, termed a remote controller, for detecting and receiving light, such as the coded light comprising the light source identifier emitted by the light source 102 as well as the light emitted by the light source 104 outside the lighting control system.

With reference to FIG. 1, a user may want to select and control a light source 102 in the lighting control system with the remote controller 106. To this end, the light sources 102 emit a unique identifier via the visible light 108. The remote control 106 has a (directional optical) receiver, which while pointing can distinguish the light contributions of the different light sources and select the relevant light source 102. This light source 102 is then controlled over a communications link, for example a radio frequency link 110, e.g. based on ZigBee. However, the selection of the light source(s) 102 by the remote controller 106 may be hindered by other light sources 104 (or by the light sources 102 themselves). The (external) light sources 104 can be light emitting diodes (LEDs), fluorescent light (FL) sources, high-intensity discharge (HID) lamps and secondary light sources such as monitors. Alternatively, they may be ambient light sources, such as the sun, moon, or a candle. The (external) light sources 104 can potentially yield a severe degradation of the selection performance. That is, the wrong light sources 102 might be selected, which creates an unacceptable user experience. In addition, properties, such as the illumination contribution, of the light source 102 itself may generate a disturbance contribution during the selection process. It is one goal of the present invention to remove the dependency of the selection performance on the presence of (interfering) sources of light.

FIG. 2 schematically illustrates the internal components of a light source 200, such as the light source 102 of FIG. 1 disclosed above. The light source 200 may thus be configured to emit illumination light as well as coded light, wherein the coded light comprises a light source identifier of the light source 200. The light source comprises an emitter 202 for emitting the coded light. The emitter 202 may comprise one or more LEDs, but it could as very well comprise one or more FL or HID sources, etc. In the IR case, typically an IR LED will be placed in proximity of the primary light source. The primary light source is associated with the illumination function of the light source (i.e. for emitting the illumination light) and can be any light source, and the secondary light source is associated with the light source identifier (i.e. for emitting the coded light). Preferably this secondary light source is a LED. The light source 200 further comprises a receiver 208 for receiving information, such as a code identifier, to assign a modified light source identifier to the light source 200. The receiver 208 may be a receiver configured to receive coded light. The receiver 208 may comprise an infrared interface for receiving infrared light.

Alternatively the receiver 208 may be a radio receiver for receiving wirelessly transmitted information. Yet alternatively the receiver 208 may comprise a connector for receiving information transmitted by wire. The wire may be a powerline cable. The wire may be a computer cable. The light source 200 may further comprise other components such as a processing unit 204 and a memory 206. The processing unit 204 may comprise a central processing unit (CPU). Particularly, the processing unit 204 may be operatively connected to the receiver 208, the memory 206 and the emitter 202. The processing unit 204 may receive information from the receiver 208 pertaining to assigning an identifier to the light source 200. Based on this information the processing unit 204 may change the encoding of the coded light such that the coded light emitted by the emitter 202 comprises the identifier. Information pertaining to the identifiers, such as code identifiers and code parameters may be stored in the memory 206. A luminaire (not shown) may comprise at least one light source 200, wherein each light source may be assigned individual light source identifiers. Alternatively, all light sources comprised in a luminaire may have been assigned the same identifier—thus this identifier in fact identifies the luminaire.

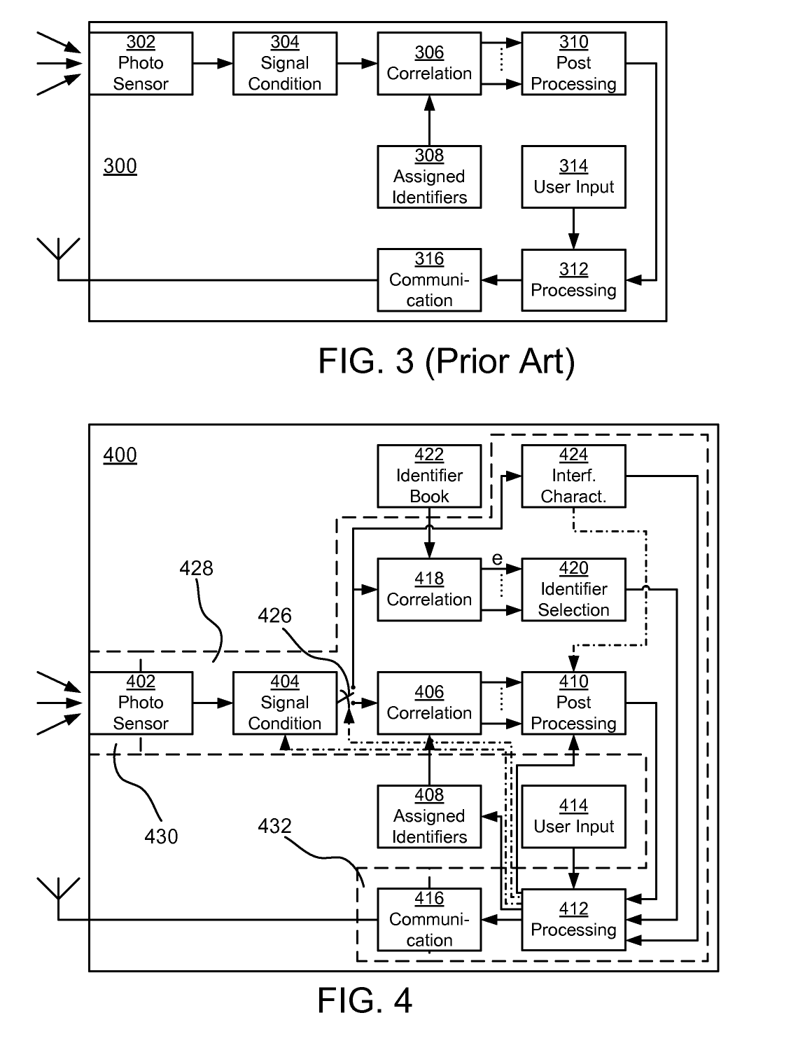

A functional block diagram for a remote controller 300 according to prior art is given in FIG. 3. The remote controller 300 comprises a photo sensor 302 arranged to receive light from different light sources, such as light from the light sources 102, 104, 200 and to convert the received light to an electrical signal. This received light may thus include light source identifiers of the light sources 102, 200 in the lighting control system, but also light from other (secondary) sources of light, such as light emitted by the light sources 104. The remote control 300 comprises a signal conditioning block 304 for filtering, amplification, digitization or the like. The remote control 300 also comprises a correlation block 306 for correlating the conditioned signal with light source identifiers assigned to light sources in the system. The light source identifiers are stored in a memory 308. Selection of a light source is based on this correlation. A processing block 312 is arranged to receive information pertaining to the selected light source. The processing block 312 is further arranged to combine this information with user input from a user input unit 314 (e.g. in form of a command to, for example, dim the selected lamp to 70%). The remote controller 300 comprises a communications interface 316 for communicating this command to the selected light source.

In this way of operating the system, the light source identifiers are assigned when light sources 102 join the lighting control system, i.e. only once. It is furthermore noted that in a special implementation of the remote controller 300 multiple parallel optical receivers (not shown) can be applied, e.g. to estimate the direction of the incoming light. The outputs of all these branches may then be fed into the post processing block 310, which is arranged to make a selection based on the combination of signals from the branches.

However, when using the remote controller 300 it may still be difficult to distinguish the light source identifiers in the received light.

A functional block diagram for a remote controller 400 according to an embodiment of the present invention is given in FIG. 4. The remote controller 400 comprises a processing unit, schematically illustrated by reference numeral 428, arranged to assign a code identifier to the light source 102 based on light received by a receiver 430 of the remote controller 400. The code identifier identifies a code to be used by the light source 102 to emit coded light being distinguishable in presence of the light. In order to achieve such an assignment the processing unit 428 is arranged to perform a number of functionalities. These functionalities will be described with reference to a plurality of functional blocks.

Similar to the a remote controller 300 of FIG. 3 the remote controller 400 comprises a photo sensor 402, a signal conditioning block 404, a correlation block 406, a memory 408 comprising identifiers, a post processing block 410, a processing block 412, a user input unit 414 and a communications interface 416.

In addition the remote controller 400 comprises a correlation block 418, an identifier selection block 420, a memory 422 comprising an identifier book, an interference characterization block 424 and a functional switch 426, functionalities of which will be disclosed below. In general, the functionalities of the signal conditioning block 404, the correlation blocks 406, 418, the post-processing block 410 block, the processing block 412, the identifier selection block 420 and the interference characterization block 424 may be implemented to be performed by the processing unit 428. Parts of the functionalities performed by the photo sensor 402 and the communications interface 416 may also be implemented to be performed by the processing unit 428.

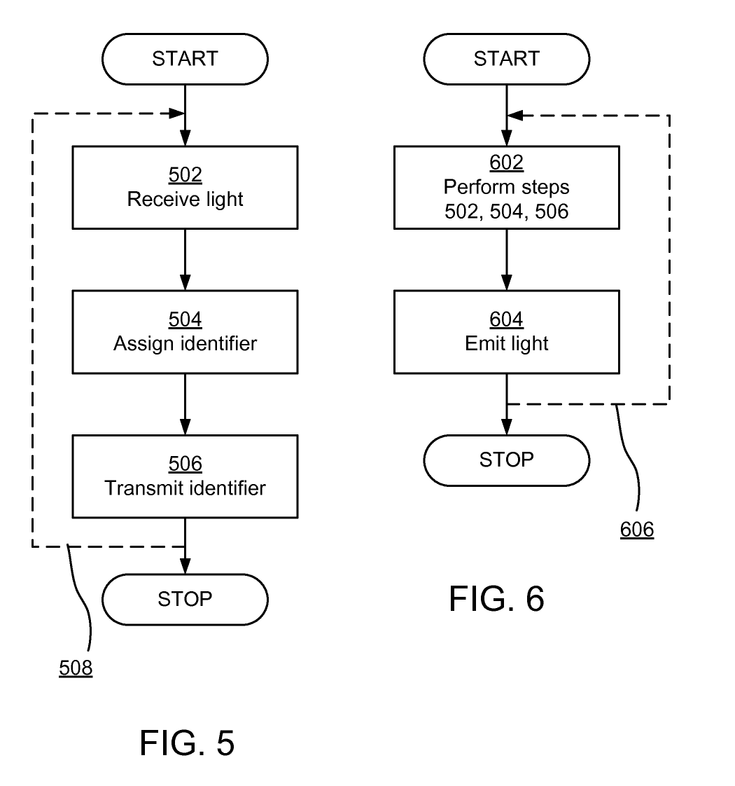

Operation of the lighting control system of FIG. 1 using the remote controller 106, 400 will now be disclosed with reference to the flowcharts of FIG. 5 and FIG. 6. The remote controller 400 receives light, step 502, step 602. The light may be received by the photo sensor 402 being part of the light receiver 430. The received signal is then passed through the signal conditioning block 404 for filtering, amplification, digitization or the like. The light may originate from one or more light sources 102, 104. One or more of these light sources may be part of the lighting control system. The light received from the light sources 102 of the lighting control system may in addition to an illumination contribution comprise a coded part. For the light sources 102 of the lighting control system the interference represents the illumination contribution, but not the identifier transmission. For example, the illumination contribution of the light source 102 may be affected by properties of the power provided to the light source 102. For example, in case the light source 102 is connected to the mains power (not shown) the power received by the light source 102 may comprise current spikes or the like. Such current spikes may result in undesired properties, such as flashes, of the emitted light. The illumination contribution of the light source 102 may be affected by properties of the hardware of the light source 102 itself. For example, imperfections or impurities may be introduced in the light emitter 202 during the manufacturing process of the light source 102. These, imperfections or impurities may affect properties of the emitted light.

When the functional switch 426 is set in its lower position the remote controller operates in a first mode of operation similar to the operation of the remote controller 300 of FIG. 3. The remote controller 400 is also associated with a second mode of operation, wherein the functional switch 426 is set in its upper position. Operation of the functional switch 426 will be further disclosed below.

In the second mode of operation (i.e. when the functional switch is set in its upper position) the remote controller 400 is arranged to receive the light also when the light sources 102 are not sending their light source identifiers, i.e. when the received light exclusively comprises an illumination contribution. In other words, the signal observed at that moment can consequently be considered interference to the reception of the light source identifiers. For example, during the assigning process the light sources 102 of the lighting control system may be commanded to all use the same “dummy code” during the coded light transmission, to not emit coded light at all, or even to be completely switched off. Thereby the received light (if any) is ensured to originate from light sources 104 not part of the lighting control system.

The received signal is in the correlation block 418 then correlated with all M (where M is an integer) possible light source identifiers stored in the identifier book 422. Alternatively, N1>M1 (where N1 and M1 are integers and where M>N1) identifiers for M1 light sources in the lighting control system can be selected. The remaining M−N1, not assigned identifiers may for example be assigned to new light sources joining the lighting control system at a later point without requiring a new correlation operation. Yet alternatively, as will be further disclosed below, the received signal may in the correlation block 418 be correlated with a subset of the light source identifiers from the identifier book stored in memory 422.

In a case the identifiers are based on frequency division multiplexing (FDM) modulation the received signal may be correlated with all possible modulation frequencies. The functionality of the correlation block 418 can be implemented efficiently using a discrete or a fast Fourier transform (DFT/FFT) operation. The output of the correlation may then be used to select a set of N2<M (where N2 is an integer) most suitable identifiers out of the M possible identifiers subject to a selection criterion used in the identifier selection block 420. A good criterion may, for example, be the selection of the identifiers that have the lowest correlation value, denoted by reference numeral symbol “e”. These identifiers can thus be considered to be most orthogonal to the experienced interference, and may yield highest suppression of the interference components. Thereby, N2 identifiers may simultaneously be selected and hence a plurality of light sources 102 may be provided with identifiers.

To reduce the complexity of the sensing, the correlation can also be applied with a subset of N3<M (where N3 is an integer) identifiers in the code book. For the FDM case for instance, only one out of two neighboring frequencies can be applied for sensing. This operation may be implemented using a lower resolution DFT. Then the sensing result for one identifier can be used to determine whether both that identifier and its neighbor should be used.

In a case the light source identifiers vary in length an alternative correlation procedure may be applied. For example, a normalized correlation procedure may be applied. According to the normalized correlation procedure the correlation output is normalized by the length of the light source identifier. One advantage of such a procedure is that the longest light source identifier is only selected when required. Alternatively, the “normal” correlation procedure as disclosed above is applied. However, if the “normal” correlation procedure is applied to light source identifiers of unequal length, typically the longest light source identifiers are selected. In comparison to short light source identifiers, long light source identifiers may cause a longer delay in receiving the identifiers by a receiver. Therefore, a set of N4<M (where N4 is an integer) values just smaller than a threshold may be selected. The threshold may be determined such that it allows for reliable operation during the actual selection or other control of the lighting control system.

As stated above the received light may comprise light source identifiers of the light source 102. That is, the assignment procedure (i.e. when the functional switch 426 is set in its upper position) is also applicable during so-called “normal” operation of lighting control system, when the light sources do emit their identifiers. Then correlation with the whole identifier book can be applied, instead of only with the assigned identifiers. The identifiers not used for identification can then be used for sensing of the interference.

For both FDM and code division multiplexing (CDM) based identifiers, respectively, different identifiers may have significantly different spectra. Correlation at the remote controller 400 with these identifiers will yield suppression of frequency components not related to these identifiers. For the FDM case this is equivalent to narrowband filtering around the considered frequency. A filter bank (e.g. arranged only to observe the fundamental frequencies of each identifier) may be implemented to provide efficient narrowband filtering. The signal at the output of the correlation block 418 can hence be considered as the interference level, relevant to the considered identifier. Hence, the lower the output, the lower the impact of the interference will be on the reception of the identifier.

The selected identifiers are subsequently communicated to the processing block 412, which is arranged to assign the selected identifiers to the different light sources. The selected identifiers are assigned to the light sources by using a code identifier. The code identifier, which is based on the received light, identifies a code to be used by the light source 102 to emit coded light being distinguishable in presence of the received light. A code identifier is thus assigned to the light source based on the received light (step 504, step 602). The chosen light source identifier is typically stored in memory 408. The identifiers stored in memory 408 may be updated during an iteration process as explained below.

The code identifying the light source identifier is transmitted to the light source (step 506, step 602). The selected code identifiers may thus be communicated to the light sources 102 and possibly to other control and sensing devices (not shown) by using the communications interface 416 being part of a transmitter 432. The light source 102 may then emit coded light based on the received code identifier (step 604).

Also, functional blocks of the remote controller 400 may be updated with information pertaining to the assigned identifiers. By knowing which of the plurality of light source identifiers are currently in use improved detection of light source identifiers may be achieved in the remote controller 400.

The power level of the received light can be estimated by the interference characterization block 424. The power level can be used to set a detection threshold in the post processing block 410. The post processing block 410 may therefore be arranged to receive information pertaining to adjustments of its parameters via the processing block 412. The post processing block 410 may alternatively be arranged to receive this information directly from the interference characterization block 424, as indicated by the dash-dotted line between blocks 424 and 410 in FIG. 4. This power level may then be used to determine whether a light source 102 is indeed observed or whether the received light is likely due to noise and/or interference. Also, the spectral profile of the received light can be estimated by the interference characterization block 424 and used to adjust some parameters of the signal conditioning block 404, e.g. by adjusting the filter response. The spectral profile relates to the frequency profile of the modulations in the received light. Thus the frequency profile corresponds to the Fourier transform of the temporal profile of the received light. The signal conditioning block 404 may therefore be arranged to receive information pertaining to adjustments of its parameters from the processing block 412, as indicated by the dash-dotted line between blocks 412 and 404 in FIG. 4.

The sensing and identifier assignment (i.e. when the functional switch 426 is set in its upper position) can be applied every time the remote controller 400 is operated. This may decrease the response time of the lighting control system. Therefore, other possibilities may include performing sensing and identifier assignment (i.e. setting the functional switch 426 in its upper position) according to the following: (i) when the lighting control system is switched on; (ii) on a regular schedule (e.g. once every 5 minutes or once every 10 selections); (iii) when the selection is not reliable anymore (indicated e.g. by a user trying to select a light source without receiving a proper acknowledgement, since the wrong light source or no light source at all was selected by the lighting control system); or (iv) when a new light source joins the lighting control system. Thus the functional switch 426 may be triggered by a timing block (not shown) or by the processing block 412, as indicated by the dash-dotted line between the processing block 412 and the functional switch 426 in FIG. 4.

The above method (or parts thereof) may be applied in an iterative manner, step 508, step 606. As an example, the method may be applied at different points in time or in different parts of the lighting control system during which data pertaining to the different applications of the method are measured and stored. The measurements may then be combined and since the measurements were taken in either another part of the environment or at a different point in time for the same environment, a better characterization of the light properties, such as interference, in the whole environment may be achieved. Thus the light source identifier may be assigned based on stored data. Thereby an increasingly better assignment of the identifiers may be accomplished. In order to simplify operation of the remote controller only the correlation for the N5<M (where N5 is an integer) best identifiers found during the previous “sensing operation” may be executed. Thereby the computational requirements of the remote controller may be reduced.

The person skilled in the art realizes that the present invention by no means is limited to the preferred embodiments described above. On the contrary, many modifications and variations are possible within the scope of the appended claims.

1. A remote controller for assigning a code identifier to a light source in a coded lighting system, the remote controller comprising:
a light receiver;
a processing unit arranged to assign a code identifier to said light source based on light received by said light receiver, said code identifier identifying a code to be used by said light source to emit coded light and being distinguishable in presence of said light; and
a transmitter arranged to transmit said code identifier to said light source.

2. The remote controller according to claim 1, wherein said processing unit is arranged to assign said code identifier based on a correlation between said received light and a plurality of light source identifiers defined by said code identifier.

3. The remote controller according to claim 2, wherein out of said plurality of light source identifiers said code identifier corresponds to a light source identifier having a minimum correlation with said received light.

4. The remote controller according to claim 2, wherein said processing unit is arranged to determine said correlation for a subset of said plurality of light source identifiers.

5. The remote controller according to claim 2, wherein said processing unit is arranged to utilize a filter bank to determine said correlation.

6. The remote controller according to claim 1, wherein said receiver is arranged to receive coded light from said light source, and wherein said assigning is based on said received coded light.

7. The remote controller according to claim 1, wherein said received light comprises light at least partly originating from at least one further light source.

8. The remote controller according to claim 7, wherein said at least one further light source is excluded from said coded lighting system.

9. The remote controller according to claim 1 wherein said lighting system comprises a plurality of light sources, and wherein said processing unit is arranged to assign a plurality of code identifiers to said plurality of light sources based on the received light, and wherein said transmitter is arranged to transmit said plurality of code identifiers to said plurality of light sources.

10. The remote controller according to claim 1, wherein said processing unit is arranged to estimate a power level of said received light, and wherein said power level is utilized to set a detection threshold in said processing unit.

11. The remote controller according to claim 1, wherein said processing unit is arranged to estimate a profile from the group consisting of a temporal profile and a spectral profile of said received light, and wherein said profile is utilized to set a filter response in said processing unit.

12. The remote controller according to claim 1, wherein at least one setting of said receiver is based on said code identifier.

13. The remote controller according to claim 1, further comprising a memory for storing data pertaining to a previously performed assignment of code identifier, and wherein said code identifier is assigned at least partially based on said data.

14. A method for assigning a code identifier to a light source in a coded lighting system, comprising the steps of:
receiving light;
assigning a code identifier to said light source based on said received light, said code identifier identifying a code to be used by said light source to emit coded light and being distinguishable in presence of said light; and
transmitting said code identifier to said light source.

15. A method of operating a coded lighting system comprising a remote controller and a light source enabled to emit coded light, said method comprising the steps of:
assigning a code identifier to said light source according to the method in claim 14; and
emitting, from said light source, coded light based on said code.
